(19) United States
(12) Patent Application Publication
(10) Pub. No.: US 2026/0323292 A1
(43) Pub. Date: Oct. 15, 2026

(54) METHOD FOR ACCESS PROTECTION OF DATA OF A RADIO FREQUENCY DEVICE

(71) Applicant: STMicroelectronics International N.V., Geneva (CH)

(72) Inventors: Philippe ALARY, Puyloubier (FR); Julien MERCIER, Mimet (FR)

(73) Assignee: STMicroelectronics International N.V., Geneva (CH)

(21) Appl. No.: 19/646,823

(22) Filed: Apr. 14, 2026

(30) Foreign Application Priority Data
Apr. 15, 2025 (FR) FR2504051

(51) Int. Cl. H04W 12/08; H04L 9/40

(52) U.S. Cl. CPC H04W 12/08; H04L 63/16

(57) ABSTRACT

Access protection of data of a radio frequency device is provided such that access to one or more data items specific to the radio frequency device is conditioned, when the radio frequency device is operating in a diagnostic mode, by one or more access configuration data items stored in a memory of the radio frequency device having certain value and the radio frequency device having a physical contact for communications connection to a device that is external to the radio frequency device.

### PRIORITY CLAIM

This application claims the priority benefit of French Application for Patent No. FR2504051, filed on Apr. 15, 2025, the content of which is hereby incorporated by reference in its entirety to the maximum extent allowable by law.

### TECHNICAL FIELD

The present disclosure generally concerns radio frequency devices and their data access protection methods.

### BACKGROUND

Radio frequency devices can be configured to be set to a diagnostic mode in which information specific to the device can be retrieved. This diagnostic mode is, for example, used for debugging or development purposes, but can also be used as an entry point for attacks.

There exists a need to improve the security of access to device-specific data when they are set to the diagnostic mode.

There is a need to overcome all or part of the disadvantages of known data access protection methods.

### SUMMARY

An embodiment provides a method of protecting the access to data of a radio frequency device, wherein, when the device is in a diagnostic mode, access to one or more data items specific to said device is conditioned by one or more access configuration data items stored in a memory of said device.

An embodiment provides a radio frequency device comprising at least one memory, the device being configured so that, when the device is in a diagnostic mode, access to one or more data items specific to the device is conditioned by one or more access configuration data items stored in said memory.

According to an embodiment, when at least a first of said access configuration data items has a first value, then the access to a first of said data items specific to the device is authorized if said device is coupled by contact to an apparatus external to the first device.

According to an embodiment, the access to said first of said data items specific to the device is not authorized if said device is coupled without contact to said apparatus.

According to an embodiment, when at least a second of said access configuration data items has a second value, then the access to at least a second of said data items specific to the device is authorized if said device is coupled by contact to said apparatus.

According to an embodiment, when said second access configuration data items has said second value, then the access to at least a second of said data items specific to the device is authorized if said device is coupled without contact to said device.

According to an embodiment, the device is set to said diagnostic mode as a result of the verification, by the device, of a reception of a predefined security code on rebooting of the device.

According to an embodiment, said data items specific to the device comprises a unique identifier of said device.

According to an embodiment, said data items specific to the device comprises an indication associated with a substrate location on which all or part of the device has been manufactured.

According to an embodiment, said memory is a register.

According to an embodiment, said memory is a non-volatile memory.

According to an embodiment, said one or more access configuration data items are stored in said memory at the time of the manufacturing of said device.

According to an embodiment, said device comprises a microcontroller.

According to an embodiment, said device is an identity document, for example a passport, an identity card, or a driver's license.

An embodiment provides a system comprising the device such as described hereabove, and an apparatus external to the device configured to: be coupled to said device; set the device to the diagnostic mode; and receive data specific to said device.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 very schematically shows in the form of blocks a system of the type to which the embodiments apply;

FIG. 2 shows an access security method;

FIG. 3 shows a step of the method of FIG. 2; and

FIG. 4 shows a step of the method of FIG. 2.

### DETAILED DESCRIPTION

The same elements have been designated by the same references in the various figures. In particular, structural and/or functional elements common to the different embodiments may have the same references and may have identical structural, dimensional and material properties.

For the sake of clarity, only those steps and elements that are useful for understanding the described embodiments have been shown and are described in detail.

Unless specified otherwise, when reference is made to elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms "front", "back", "top", "bottom", "left", "right", etc., or relative position qualifiers, such as the terms "top", "bottom", "upper", "lower", etc., or orientation qualifiers, such as "horizontal", "vertical", etc., reference is made unless otherwise specified to the orientation of the drawings.

Unless specified otherwise, the expressions "about", "approximately", "substantially", and "in the order of" signify plus or minus 10% or 10°, preferably of plus or minus 5% or 5°.

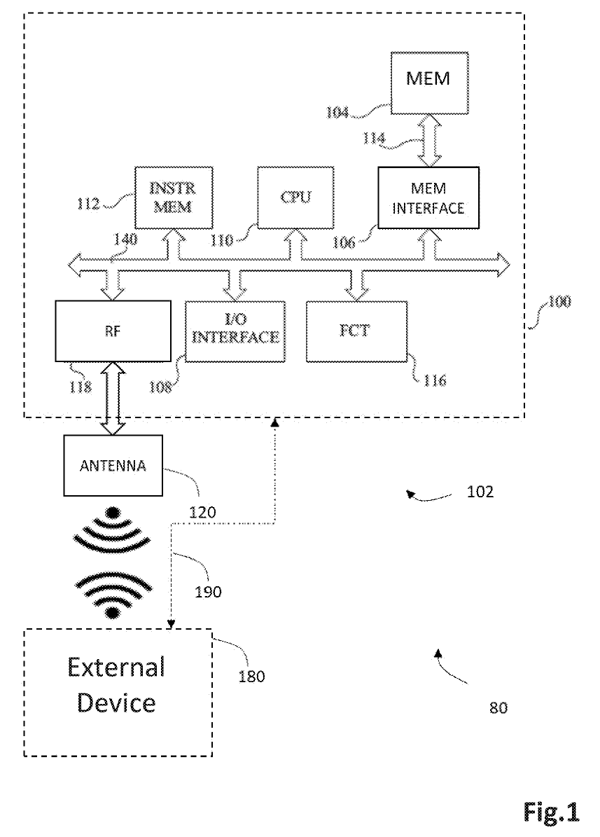

FIG. 1 very schematically shows in the form of blocks a system 80 of the type to which the embodiments apply.

System 80 comprises, for example, a device 102. Device 102 comprises, for example, a microcontroller 100 capable of communicating wirelessly, via an antenna 120 (ANTENNA), or via a physical link 190, with another device or apparatus 180, external to device 102.

Device 102 is, for example, an identity document, such as a passport, an identity card, or a driver's license, or a transport ticket, an admission ticket, or an access control ticket. In an example, device 102 is a passive radio frequency device, that is, not powered internally but rather is powered by an electromagnetic field originating from the external apparatus or device 180. For example, device 102 may comprise a card and device 180 may comprise a card reader.

The wireless communication may be operated via communication protocols such as NFC, WIFI, BLUETOOTH, etc.

Physical connection 190 corresponds, for example, to a direct contact via connection terminals, not shown. Physical link 190 is, for example, a wired link. Link 190 uses, for example, a UART-type or an I2C-type communication protocols.

Microcontroller 100 comprises, for example, a non-volatile memory 104 (MEM), for example of FLASH or phase-change memory type, capable of communicating, via a communication bus 114, with a non-volatile memory interface 106 (MEM INTERFACE) configured to write or read data into and from non-volatile memory 104. In an example, system programs and/or applications, such as boot programs, are implemented in memory 104. Memory 104 comprises, for example, a program configured to manage other programs stored within memory 104. These other programs are, for example, applications developed by users of the microcontroller, or also wireless protocol stacks which enable, when they are executed, to implement a wireless data communication with apparatus 180, for example. Memory 104 may further comprise a program enabling to implement a diagnostic evaluation of device 102.

Microcontroller 100 further comprises, for example, a processing unit 110 (CPU) comprising one or more processors under control of instructions stored in a system instruction memory 112 (INSTR MEM). Instruction memory 112 is, for example, a volatile random access memory (RAM). Processing unit 110 and memory 112 communicate, for example, via a system (data, address, and control) bus 140. Memory 104 is coupled to system bus 140 via non-volatile memory interface 106 and via bus 114. Microcontroller 100 further comprises an input/output interface 108 (I/O INTERFACE) coupled to system bus 140 to communicate with the outside. Physical link 190 is, for example, coupled to block 108.

Microcontroller 100 may integrate other circuits implementing other functions (for example, one or more volatile and/or non-volatile memories, other processing units), symbolized by a block 116 (FCT) in FIG. 1.

In the example of FIG. 1, the memories of blocks 104, 112, 116 may comprise one or more registers. Registers may also be comprised in other blocks of microcontroller 100. The content of some of these registers is, for example, written on manufacturing of device 102, for example to be used as a configuration for the operation of device 102.

Microcontroller 100 may further integrate other circuits, such as wireless communication circuits 118 (RF) having, for example, impedance matching circuits and which are configured to be connected to antenna 120.

To be able to diagnose device 102, for example for development or debugging purposes, device 102 comprises a diagnostic mode which is, for example, a program, or a computer code, which, when it is executed, enables to access parameters of device 102. These parameters comprise, for example, parameters specific to each of the manufactured devices 102, or traceability or operating parameters, or an identifier unique to device 102, or a serial number, or information or an indication associated with a substrate location on which all or part of device 102 has been manufactured.

In an example, the diagnostic mode is implemented by device 102 when device 102, after rebooting, for example during a given period of time after rebooting, receives a security code which is dedicated to starting of the diagnostic mode. The reception of the security code may occur when device 102 is connected physically (that is, by contact), or without contact, to apparatus 180. The security code is, for example, sent by apparatus 180, which desires access to the parameters of device 102 which are accessible in diagnostic mode. The security code comprises, for example, a plurality of bytes.

It is possible for a malicious person to desire to use the setting to the diagnostic mode of device 102 to retrieve, for example, the unique identifier of device 102, in order to subsequently track it. For example, in the case where device 102 is integrated in a passport, the unique identifier of device 102 would enable to link device 102 to the name of a person in possession of device 102.

A solution to limit this risk would be that, when device 102 is set to the diagnostic mode, access to the parameters of the diagnostic mode is authorized when device 102 is connected to apparatus 180 with a physical contact (for example through link 190), but that access to the parameters of the diagnostic mode is not allowed when device 102 is connected to apparatus 180 without contact. It is thus considered that the fact of being able to access device 102 by physical contact is more difficult than without contact.

However, this solution lacks flexibility of use for users of device 102.

In order to alleviate this problem, the embodiments provide a method for protecting the access to data of device 102, in which, when device 102 is in diagnostic mode, access to one or more data items specific to said device is conditioned by one or more access configuration data items stored in a memory, for example a register, of said device 102.

This enables a user of device 102 to select, for example, upon manufacturing by programming the memory or the register, the parameters that can be accessible or not according, for example, to the connection mode between device 102 and apparatus 180.

This further enables to limit the traceability of an individual from the device 102 that they have in their possession.

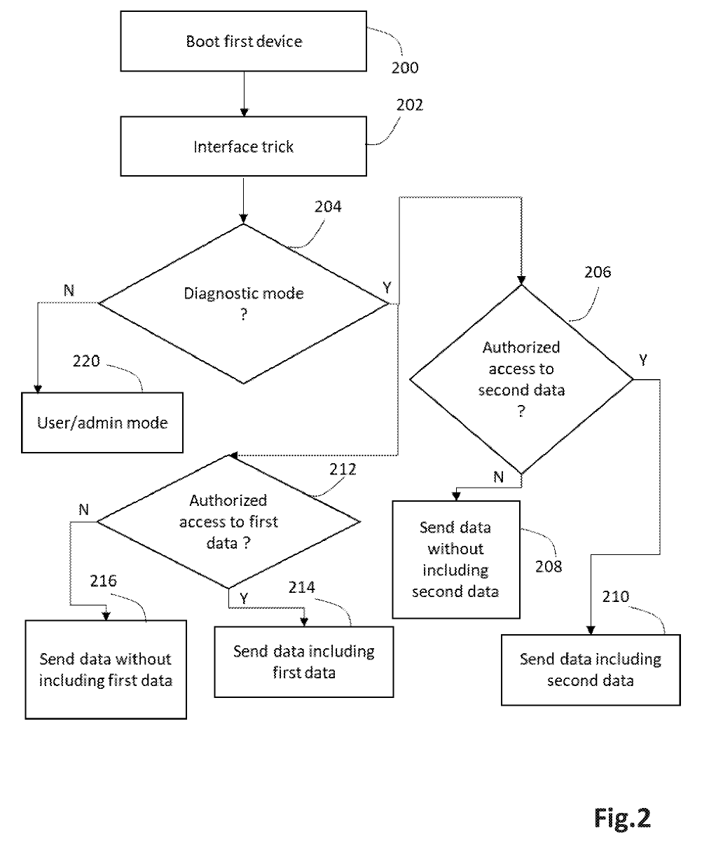

FIG. 2 shows an access security method according to an embodiment.

In a step 200 (Boot first device), device 102 is rebooted.

In a step 202 (Interface trick), subsequent to step 200, device 102 verifies whether it has received the security code. This step lasts, for example, for a given time immediately following boot.

In a step 204 (Diagnostic mode?), subsequent to step 202, if the security code received by device 102 is the security code expected to enter the diagnostic mode, then (branch Y) steps 206 (Authorized access to second data?) and 212 (Authorized access to first data?) are implemented, at the same time or successively in a defined order. If the security code received by device 102 is not the security code expected to enter the diagnostic mode, or no security code has been received within the given time, then (branch N) a step 220 (User/admin mode) is implemented.

In step 212, device 102 verifies, by using a value from a memory or from one or more registers of device 102, the configuration of the access to a first data item, or first parameter, specific to device 102. In an example, for each data item specific to the device, the memory or register may take a first and a second value (for example, 0 or 1). The first and the second values may, for example, each be encoded over one or more bits. The access restriction configuration associated with a data item specific to device is, for example, a function of its first and second values. The first value corresponds to a certain access restriction configuration (for example access forbidden during a contactless mode) associated with a data item, and the second value corresponds to another configuration of restriction of the access (for example, access authorized for a contactless mode) to this same data item. The configuration takes into account, for example, the type of connection established between device 102 and apparatus 180. A plurality of data items specific to the device may have an access restriction configured in the memory or the register. In an example, the memory, or register, in which the configuration of the restriction of the access to the first data item is stored, for example form part of one of blocks 104, 112, 116. In another example, the memory, or register, are stored in another block of microcontroller 100 which is not illustrated in the drawings. If the access restriction configuration indicates that the access to the first data item is authorized with the current connection mode (contact or non-contact), then (branch Y) a step 214 (Send data including first data) is implemented. If the access restriction configuration indicates that the access to the first data item is not authorized with the current connection mode, then (branch N) a step 216 (Send data without including first data) is implemented.

In step 214, the first data item is sent to apparatus 180. Other data authorized to be sent may also be sent at the same time.

In step 216, the first data item is not sent to apparatus 180. Other data authorized to be sent may be sent, but not the first data item.

In step 206, device 102 verifies, for example in the memory or in the register of device 102, the configuration of the access to the second data item, or second parameter, specific to device 102. The configuration takes into account, for example, the type of connection established between device 102 and apparatus 180. If the access restriction configuration indicates that access to the second data item is authorized with the current connection mode (contact or non-contact), then (branch Y) a step 210 (Send data including second data) is implemented. If the access restriction configuration indicates that the access to the first data item is not authorized with the current connection mode, then (branch N) a step 208 (Send data without including second data) is implemented.

In step 210, the second data item is sent to apparatus 180. Other data authorized to be sent may also be sent at the same time.

In step 208, the second data item is not sent to apparatus 180. Other data authorized to be sent may be sent, but not the second data item.

In step 220 (User/admin mode), device 102 implements a user operation or administrator access program, or application, or any other program provided in standard operation after rebooting.

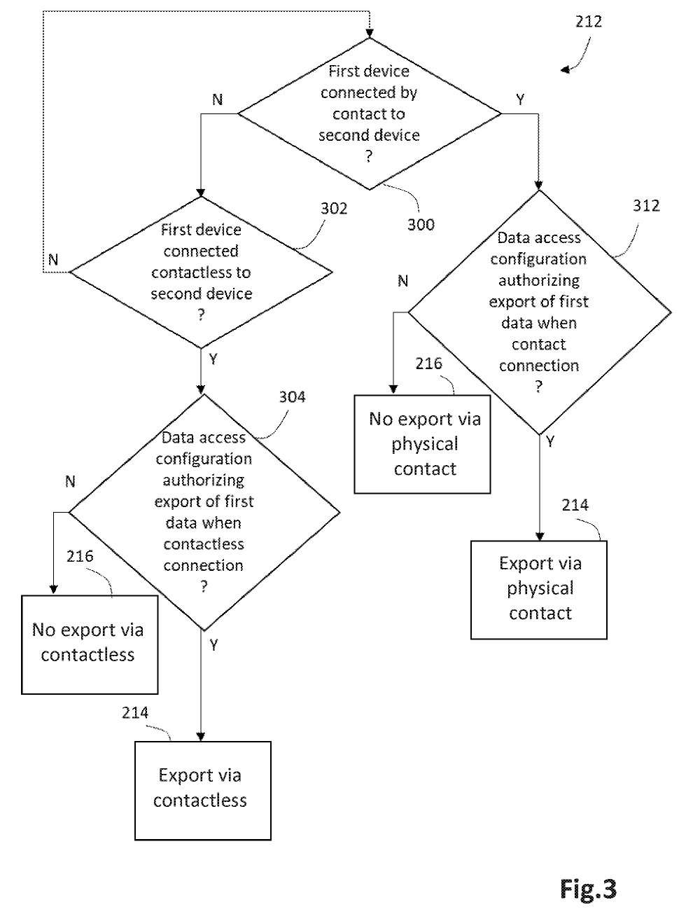

FIG. 3 shows a step of the method of FIG. 2. In particular, FIG. 3 shows an embodiment of the step 212 of FIG. 2.

In a step 300 (First device connected by contact to second device?), device 102 identifies by which type of connection (physical contact (e.g., link 190) or contactless (e.g., using antenna 120) it is in communication with apparatus 180. The type of connection can be identified, for example, if communication frames are received via block 118 or rather via blocks 116. If it is a physical contact (Y branch), then a step 312 (Data access configuration authorizing export of first data when contact connection?) is implemented. If it is not a physical contact (branch N), then a step 302 (First device connected contactless to second device?) is implemented.

In step 312, if the memory or register of device 102, which comprises the access restriction configuration, indicates that the first data item, or the first parameter, can be exported in the case of a connection by physical contact, then (branch Y), step 214 is implemented. If the memory, or register, of device 102 indicates that the first data item cannot be exported in the case of a connection by physical contact, then (branch N), step 216 is implemented.

In step 302, device 102 verifies whether device 102 and apparatus 180 are communicating without contact, that is, wirelessly. If this is the case (branch Y), then a step 304 (Data access configuration authorizing export of first data when contactless connection?) is implemented. If this is not the case (branch N), then step 300 is implemented, for example.

In step 304, if the memory or register of device 102, which comprises the access restriction configuration, indicates that the first data item or parameter can be exported in the case of a contactless connection, for example by radio frequency communication, then (branch Y), step 214 is implemented. If the memory, or register, of device 102 indicates that the first data item cannot be exported in the case of a contactless connection, then (branch N), step 216 is implemented.

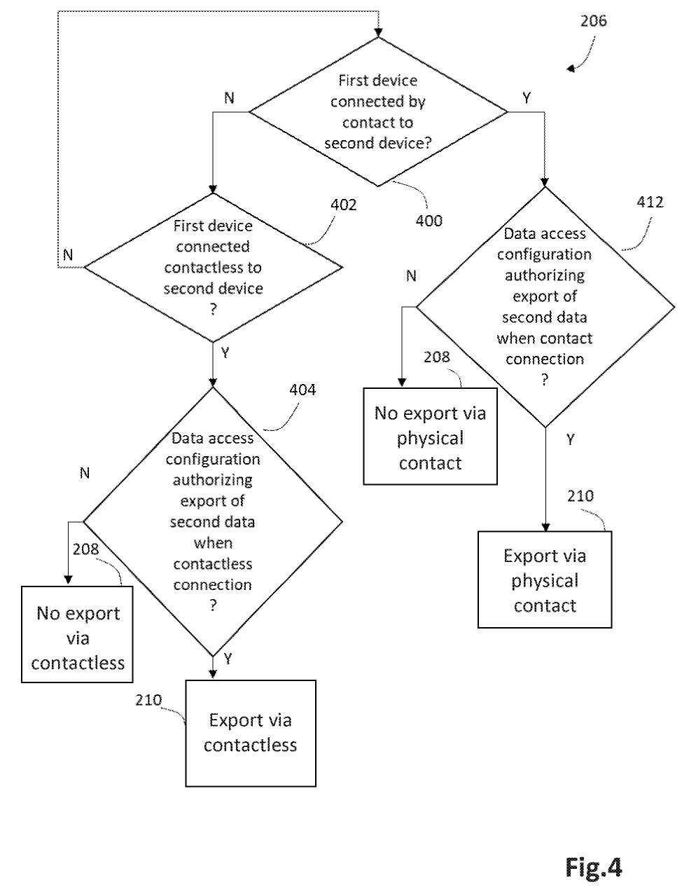

FIG. 4 shows a step of the method of FIG. 2. More particularly, FIG. 4 shows an embodiment of step 206.

In a step 400 (First device connected by contact to second device?), device 102 identifies by which type of connection (physical contact (e.g., link 190) or contactless (e.g., using antenna 120) it is in communication with apparatus 180. The type of connection can be identified, for example, if communication frames are received via block 118 or rather via blocks 116. If it is a physical contact (Y branch), then a step 412 (Data access configuration authorizing export of second data when contact connection?) is implemented. If it is not a physical contact (branch N), then a step 402 (First device connected contactless to second device?) is implemented.

In step 412, if the memory or register of device 102, which comprises the access restriction configuration, indicates that the second data item or parameter can be exported in the case of a connection by physical contact, then (branch Y), step 210 is implemented. If the memory, or register, of device 102 indicates that the second data item cannot be exported in the case of a connection by physical contact, then (branch N), step 208 is implemented.

In step 402, device 102 verifies whether device 102 and apparatus 180 are communicating without contact, that is, wirelessly. If this is the case (branch Y), then a step 404 (Data access configuration authorizing export of second data when contactless connection?) is implemented. If this is not the case (branch N), then step 400 is implemented, for example.

In step 404, if the memory or register of device 102, which comprises the access restriction configuration, indicates that the second data item, or the second parameter, can be exported in the case of a contactless connection, for example by radio frequency communication, then (branch Y) step 210 is implemented. If the memory, or register, of device 102 indicates that the second data item cannot be exported in the case of a contactless connection, then (branch N) step 208 is implemented.

Various embodiments and variants have been described. Those skilled in the art will understand that certain features of these various embodiments and variants may be combined, and other variants will occur to those skilled in the art. In particular, it is possible for the access restriction configuration to discriminate other types of connections, such as the type of radio frequency protocol used, or also device environment parameters at the time of the connection.

Finally, the practical implementation of the described embodiments and variants is within the abilities of those skilled in the art based on the functional indications given hereabove. In particular, regarding the access restriction configuration, it may involve bit values of a register, for example, the values of a given bit of the register signifying that the access to the associated parameter is allowed or not to be exported to apparatus 180. Further, although FIGS. 2-4 illustrate the case where device 102 verifies whether the first and second data items can be exported, those skilled in the art will be able to apply their knowledge and the teachings of the present description to implement cases where only one data item is concerned or the case where more than two data items are concerned.

1. A method of protecting data access for a radio frequency device, comprising:
entering a diagnostic mode for the radio frequency device;
when in the diagnostic mode, conditioning access to one or more data items specific to said radio frequency device dependent on one or more access configuration data items stored in a memory of said radio frequency device;
wherein conditioning access comprises authorizing access to a first of said one or more data items specific to the radio frequency device when:
at least a first of said one or more access configuration data items has a first value; and
said radio frequency device is coupled for communication with a device that is external to the radio frequency device by use of a physical contact.

2. The method according to claim 1, wherein access to said first of said one or more data items specific to the radio frequency device is not authorized when said radio frequency device is coupled for communication without physical contact to said device that is external to the radio frequency device.

3. The method according to claim 1, further comprising verifying, by the radio frequency device, a reception of a predefined security code on rebooting of the radio frequency device, and setting the radio frequency device to enter said diagnostic mode in response to the verification.

4. The method according to claim 1, wherein said one or more data items specific to the radio frequency device comprise a unique identifier of said radio frequency device.

5. The method according to claim 1, wherein said one or more data items specific to the radio frequency device comprise an indication associated with a substrate location on which all or part of the radio frequency device has been manufactured.

6. The method according to claim 1, wherein said memory is a register.

7. The method according to claim 1, wherein said memory is a non-volatile memory.

8. The method according to claim 1, wherein said one or more access configuration data items are stored in said memory at a time of a manufacturing of said radio frequency device.

9. The method according to claim 1, wherein said radio frequency device comprises a microcontroller.

10. The method according to claim 1, wherein said radio frequency device is an identity document.

11. A radio frequency device, comprising:
at least one memory that stores one or more access configuration data items;
control circuitry configured, when the radio frequency device is in a diagnostic mode, to condition access to one or more data items specific to said radio frequency device dependent on said one or more access configuration data items;
wherein the control circuitry conditions access by authorizing access to a first of said one or more data items specific to the radio frequency device when:
at least a first of said one or more access configuration data items has a first value; and
said radio frequency device is coupled for communication with a device that is external to the radio frequency device by use of a physical contact.

12. The radio frequency device according to claim 11, wherein the control circuit is further configured to not authorize access to said first of said one or more data items specific to the radio frequency device when said radio frequency device is coupled for communication without physical contact to said device that is external to the radio frequency device.

13. The radio frequency device according to claim 11, wherein the control circuit is further configured to verify a reception of a predefined security code on rebooting of the radio frequency device, and set the radio frequency device to enter said diagnostic mode in response to the verification.

14. The radio frequency device according to claim 11, wherein said one or more data items specific to the radio frequency device comprise a unique identifier of said radio frequency device.

15. The radio frequency device according to claim 11, wherein said one or more data items specific to the radio frequency device comprise an indication associated with a substrate location on which all or part of the radio frequency device has been manufactured.

16. The radio frequency device according to claim 11, wherein said memory is a register.

17. The radio frequency device according to claim 11, wherein said memory is a non-volatile memory.

18. The radio frequency device according to claim 11, wherein said one or more access configuration data items are stored in said memory at a time of a manufacturing of said radio frequency device.

19. The radio frequency device according to claim 11, wherein said control circuitry comprises a microcontroller.

20. The radio frequency device according to claim 11, wherein said radio frequency device is an identity document.

21. A system, comprising:
the radio frequency device according to claim 11; and
the device that is external to the radio frequency device;
wherein said device is configured to: be physically coupled to said radio frequency device; set the radio frequency device to the diagnostic mode; and receive data specific to said radio frequency device.
